(19) United States
(12) Patent Application Publication
(10) Pub. No.: US 2011/0217034 A1
(43) Pub. Date: Sep. 8, 2011

(54) SPACER MEMBER FOR CAMERA MODULE AND CAMERA MODULE EQUIPPED WITH THE SAME

(75) Inventors: Jae Chang You, Ansan-city (KR); Duk Yeol Lee, Ansan-city (KR); Ji Hoon Lim, Ansan-city (KR)

(73) Assignee: HYSONIC CO., LTD., Ansan-city (KR)

(21) Appl. No.: 13/002,604

(22) PCT Filed: Nov. 23, 2009
(86) PCT No.: PCT/KR2009/006902

§ 371 Date: Jan. 4, 2011

(30) Foreign Application Priority Data
Nov. 25, 2008 (KR) 10-2008-0117420

(51) Int. Cl. G03B 17/00

(52) U.S. Cl. 396/529; 396/439

(57) ABSTRACT

Provided is a spacer member of a camera module which fixes a border of an elastic member for elastically supporting a lens holder upward and downward to a housing, and a camera module equipped with the same. The spacer member for a camera module, which is disposed between a cover and a plate spring of the camera module so as to fix a border of the plate spring to a housing, is characterized in that the spacer member is formed of an elastic material having cushion performance, and the spacer member is compressed toward the plate spring by the cover so that the plate spring is fixedly compressed to the housing.

### CROSS-REFERENCE(S) TO RELATED APPLICATIONS

The present invention claims priority of Korean Patent Application No. 10-2008-0117420, filed on Nov. 25, 2008, the contents of which are incorporated herein by reference.

### BACKGROUND OF THE INVENTION

1. Field of the Invention

The present invention relates to a spacer member of a camera module and a camera module equipped with the same, and particularly to a spacer member of a camera module which fixes a border of an elastic member for elastically supporting a lens holder upward and downward to a housing, and a camera module equipped with the same.

2. Description of Related Art

As the development of a camera module is accelerated, the camera module is applied to various electronics such as a notebook, PMP and MP3, as well as a digital camera.

Particularly, the camera module is provided at most of mobile phones, and the frequency of use is also increased.

FIGS. 1 and 2 show a conventional camera module 400.

Referring to FIGS. 1 and 2, the camera module 400 includes a lens group 500, a lens holder 550, a housing 600, a plate spring 650, a spacer member 700, a cover 750, a driving part 800 and a control part 850.

The lens group 500 is comprised of a plurality of lenses in order to change a magnification of a subject. The lens group 500 is fixed to the lens holder 550.

The lens holder 550 is disposed in the housing 600, and the plate spring 650 is disposed at an upper end of the lens holder 550.

The plate spring 650 functions to elastically support the lens holder 550 so that the lens holder 550 can be guided up and down and moved in an optical axial direction.

Further, a border of the plate spring 650 contacted with the upper end of the lens holder 550 is disposed at an upper end of the housing 600, and the spacer member 700 is stacked on the border of the plate spring 650 and bonded together with the plate spring 650 to the housing 600 using an adhesive agent.

The driving part 800 is disposed between the housing 600 and the lens holder 550 so as to lift the lens holder 550, and the control part 850 including an image sensor for taking an image of the subject passing through the lens group is disposed at a lower end of the housing 600.

Further, the cover 750 is disposed at an upper side of the spacer member 700 so as to cover an upper surface and a side surface of the housing 600. The cover 750 is hooked to a protrusion formed at the side surface of the housing 600.

Meanwhile, the spacer member 700 is disposed between the plate spring 650 and the cover 750. The spacer member 700 functions to prevent the plate spring 650 from being interfered with the cover 750.

The space member 700 formed of a general synthetic resin is formed by injection molding.

Therefore, if a height tolerance of the spacer member 700 is not managed appropriately, it is apprehended that assembly defect of the cover 750 is occurred when assembling the cover 750.

In other words, in case that a space is generated between the spacer member 700 and the cover 750 due to a low height of the spacer member 700, a foreign substance may be penetrated through the space. In case that a height of the spacer member 700 is high, the side surface of the cover 750 does not reach the protrusion of the housing 600, and thus the cover 750 is not coupled completely with the housing 600.

Further, the spacer member 700 is bonded together with the plate spring to the upper surface of the housing 600 using an adhesive agent.

A large error occurs in a height between the housing 600 and the cover 750 due to the adhesive agent, thereby deteriorating an assembly performance.

In order to solve the above problems, it is necessary to precisely machine the height of the spacer member 700, but there is difficulty in managing a dimension of the height of the spacer member 700.

### SUMMARY OF THE INVENTION

An embodiment of the present invention is directed to providing a spacer member of a camera module and a camera module equipped with the same, which can allow a height of the spacer member to be elastically changed, thereby enhancing assembly performance.

To achieve the object of the present invention, the present invention provides a spacer member for a camera module, which is disposed between a cover and a plate spring of the camera module so as to fix a border of the plate spring to a housing, wherein the spacer member is formed of an elastic material having cushion performance, and the spacer member is compressed toward the plate spring by the cover so that the plate spring is fixedly compressed to the housing.

Preferably, the spacer member is formed of urethane foam.

Preferably, a rib portion is formed at each corner of the spacer member, and the rib portion is formed with a fixing hole, and a fixing protrusion that is inserted into the fixing hole is formed at the housing.

Further, the present invention provides a camera module equipped with a spacer module, including a housing; a lens holder which is disposed at the housing to be movable up and down, and in which a lens is inserted; an image sensor which is disposed at a lower side of the lens holder so as to take an image of a subject passing through the lens; a plate spring which is disposed at an upper side of the housing so as to be contacted with the lens holder and to elastically support the lens holder upward and downward; a spacer member which is disposed at an upper side of the plate spring so as to fix a border of the plate spring to the housing; and a cover which is disposed at an upper side of the spacer member so as to cover the spacer member and housing, wherein the spacer member is formed of an elastic material having cushion performance, and the spacer member is compressed toward the plate spring by the cover so that the plate spring is fixedly compressed to the housing.

### BRIEF DESCRIPTION OF THE DRAWINGS

FIG. 1 is a perspective view of a conventional camera module.

FIG. 2 is an exploded perspective view of the conventional camera module.

FIG. 3 is a perspective view of a space module for a camera module according to an embodiment of the present invention.

FIG. 4 is a perspective view of a camera module equipped with the spacer member according to the embodiment of the present invention.

FIG. 5 is an exploded perspective view of the camera module equipped with the spacer member according to the embodiment of the present invention.

FIGS. 6 and 7 are assembled views of the spacer member according to the embodiment of the present invention when seeing from a line A-A of FIG. 4.

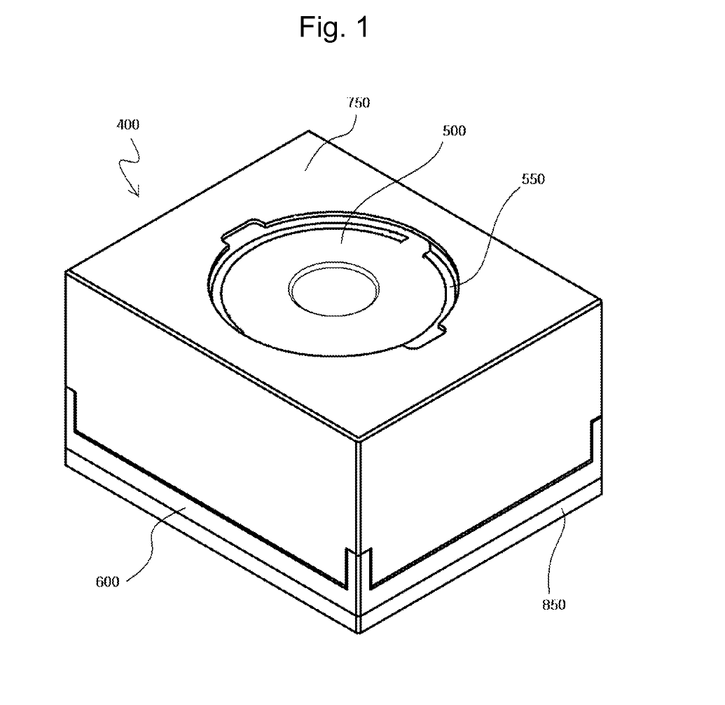

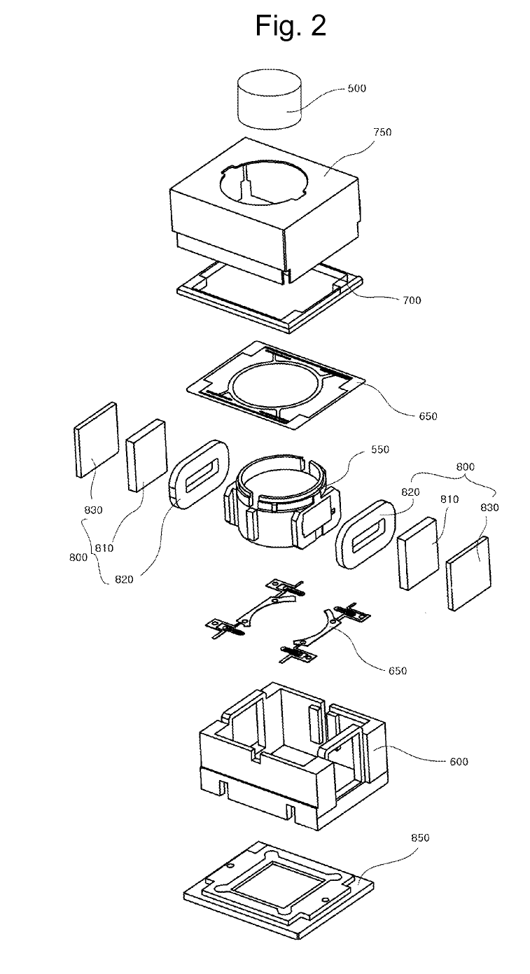

### DESCRIPTION OF SPECIFIC EMBODIMENTS

The advantages, features and aspects of the invention will become apparent from the following description of the embodiments with reference to the accompanying drawings, which is set forth hereinafter.

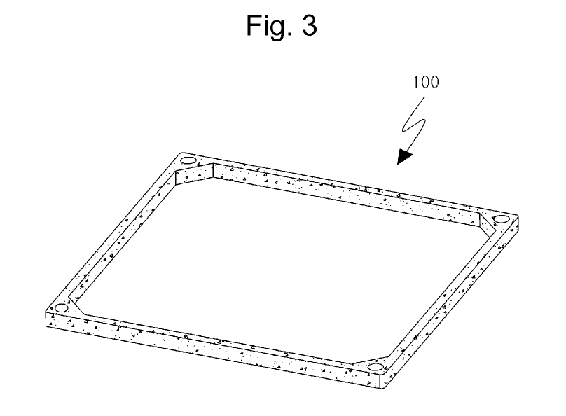

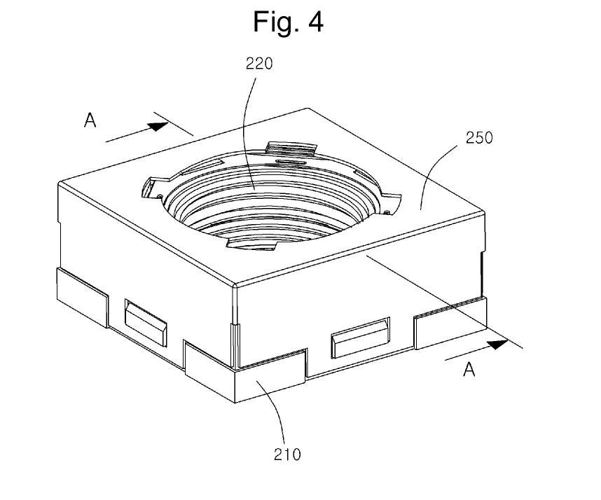

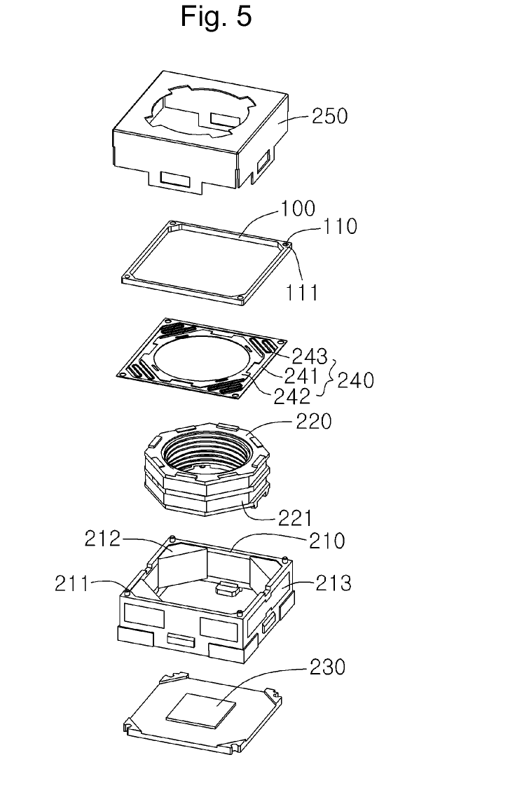

FIG. 3 is a perspective view of a space module for a camera module according to an embodiment of the present invention, FIG. 4 is a perspective view of a camera module equipped with the spacer member according to the embodiment of the present invention, and FIG. 5 is an exploded perspective view of the camera module equipped with the spacer member according to the embodiment of the present invention.

As shown in FIG. 3, a spacer member 100 is formed into a rectangular ring shape and formed of an elastic material having cushion ability.

Like a sponge, the spacer member 100 is compressed when external force is applied, and then returned to an original state when the external force is released.

Further, the spacer member 100 has a small size having a thickness and height of about 0.5-1 mm, and thus preferably formed of urethane foam having high cushion ability and processability.

The urethane foam is a foaming product which is manufactured by mixing polyurethane, as a component material, obtained by reaction of an isocyanate compound and glycol, and a volatile solvent, as a foaming agent, such as carbon dioxide and Freon generated by reaction of isocyanate and water as a cross-linking agent.

Since the urethane foam has a minute and uniform cell structure, it is proper to manufacture the small spacer member 100.

Further, the convention spacer member is disposed between the cover and the plate spring of the camera module, and functions to prevent the plate spring from being interfered with the cover. However, the spacer member 100 formed of the elastic material according to the present invention also functions to pressure-fix a border of the plate spring to the housing.

Detailedly, as shown in FIGS. 4 and 5, a camera module 200 equipped with the spacer member of the present invention includes a housing 210, a lens holder 220, an image sensor 230, a plate spring 240, a cover 250 and the spacer member 100.

The housing 210 is formed into a hexahedral shape, and upper and lower ends of the housing 210 are opened. A fixing protrusion 211 that is inserted into the spacer member 100 is formed at each corner portion of the upper end of the housing 210.

Further, the lens holder 220 is disposed in the housing 210 so as to be moved up and down.

The lens holder 220 is formed into an octagonal cylinder shape and multiple lenses (not shown) for changing a magnification of a subject are disposed in the lens holder 220.

A coil 221, a magnet 212 and a yoke 213 which drive the lens holder 220 up and down are disposed between the housing 210 and the lens holder 220. The lens holder 220 is moved up and down by electromagnetic force generated when power is applied to the coil 221.

Furthermore, the image sensor 230 for taking an image of the subject passing through the lens is disposed at a lower side of the lens holder 220, and the plate spring 240 which is disposed at an upper side of the housing 210 and also contacted with the lens holder 220 so as to elastically support the lens holder 220 upward and downward is disposed at an upper side of the lens holder 220.

The plate spring 240 is formed of a rectangular thin metal plate. The plate spring 240 includes a first fixing portion 241 which is contacted with the housing 210, a second fixing portion 242 which is contacted with the lens holder 220, and an elastic portion 243 which is formed to be curved between the first and second fixing portions 241 and 242 and also to be expanded and contracted when the lens holder 220 is moved up and down.

Meanwhile, the spacer member 100 is disposed at the upper side of the plate spring 240 so as to be contacted with the first fixing portion 241 of the plate spring 240.

That is, an outer width of the spacer member 100 is equal to or less than an outer width of the first fixing portion 241. An inner width of the spacer member 100 is equal to or less than an inner width of the fixing portion 241 and also contacted with an upper surface of the first fixing portion 241.

Further, the cover 250 is disposed at an upper side of the spacer member 100 so as to cover the housing 210.

The cover 250 is formed into a rectangular shape, and an outer surface of the housing 210 is bent to the housing 210 so as to cover the housing 210.

When the cover 250 is assembled to the housing 210, the cover 250 compresses the spacer member 100 toward the plate spring 240, and is hooked and fixed to a side surface of the housing 210.

The spacer member 100 formed of an elastic material is compressed toward the housing 210. And the spacer member 100 compresses fixedly the plate spring 240 toward the housing 210 using expansion force of the spacer member 100 as restoring forcer thereof.

A rib portion 110 is formed at each corner of the spacer member 100.

The rib portion 110 functions to connect adjacent inner surfaces of the spacer member 100 to each other and thus to prevent the spacer member 100 from being cut.

Further, the rib portion 110 is formed with a fixing hole 111 in which the fixing protrusion 211 of the housing 210 is inserted.

As described above, since the fixing hole 111 is formed at the rib portion 110 and also the fixing protrusion 211 inserted into the fixing hole 111 is formed at the housing 210, the spacer member 100 is guided to a proper position when the spacer member 100 is assembled to the housing 210, and thus it is possible to facilely perform the assembling process and to prevent the spacer member 100 from being separated by an external impact.

Hereinafter, an assembled state of the spacer member according to the embodiment of the present invention will be described.

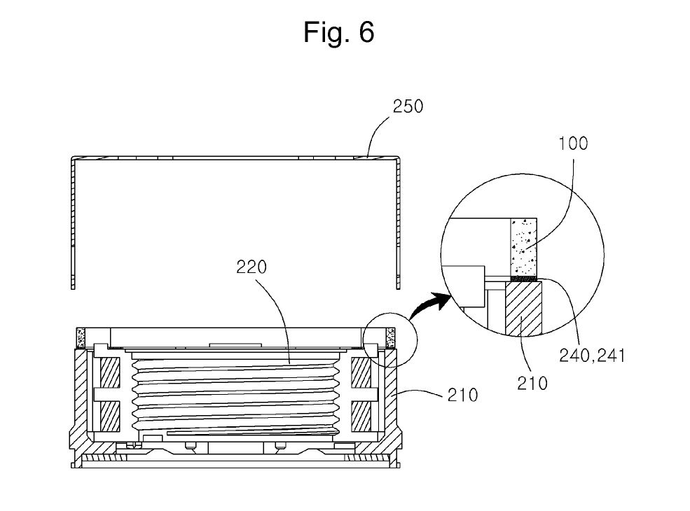

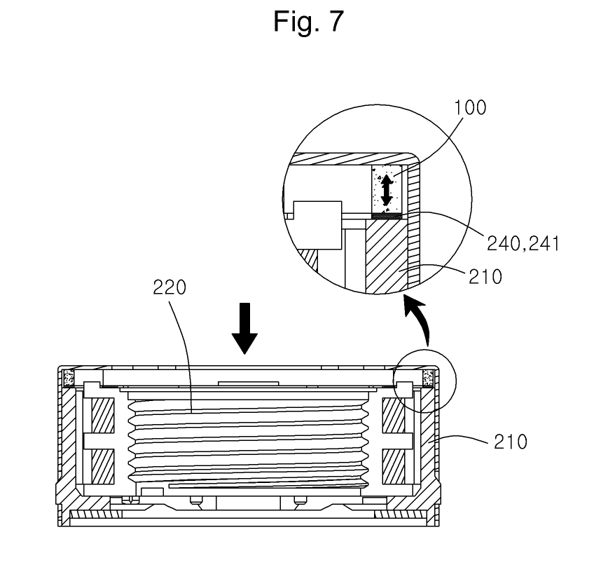

FIGS. 6 and 7 are assembled views of the spacer member according to the embodiment of the present invention when seeing from a line A-A of FIG. 4.

As shown in FIG. 6, before the cover 250 is assembled, the spacer member 100 is disposed at the upper side of the plate spring 240, and the state is maintained so that any force is not exerted to an outside.

As shown in FIG. 7, the cover 250 is fixedly coupled to the housing 210, such that the spacer member 100 is compressed to some extent and thus has a desired height.

That is, since the spacer member 100 is compressed toward the housing 210, the height of the compressed spacer member 100 is formed to be smaller than an original height thereof.

Therefore, the spacer member 100 fills completely a gap between the plate spring 240 and the cover 250 due to the expansion force thereof.

At this point, the cover 250 is fixedly hooked to the housing 210 so as to be not separated.

As described above, since the spacer member 100 is formed of the elastic material having the cushion performance, it is possible to completely close the gap between the housing 210 and the cover 250 and thus to prevent the foreign substance from being introduced inside the camera module.

The plate spring 240 disposed at the lower side of the spacer member 100 is closely contacted with the housing 210 by the expansion force of the spacer member 100.

In other words, the plate spring 240 is fixedly compressed by the spacer member 100 without a separate bonding operation.

Herein, since the height of the spacer member 100 is elastically changed according to whether the cover 250 is assembled, the height of the space member 100 is larger than a distance between the cover 250 and the plate spring 240 when the external force is not exerted to the spacer member 100, and the height thereof is smaller than the distance between the cover 250 and the plate spring 240 when the external force is exerted to the spacer member 100.

Since the spacer member 100 is formed of the elastic material having the cushion performance, and the spacer member 100 is compressed toward the plate spring 240 by the cover 250 so that the plate spring 240 is fixedly compressed to the housing 210, it is possible to fix the spacer member 100 to the housing 210 without the separate bonding operation. Since the height of the spacer member 100 is elastically changed, it is not necessary to precisely form the height of the spacer member 100, thereby improving the workability and assembly performance.

The present invention can be applied to the spacer member and the camera module equipped with the same, so that the height of the spacer member is elastically changed according to whether the cover is assembled, thereby enhancing the assembly performance.

According to the present invention as described above, since the spacer member is formed of the elastic material having the cushion performance, and the spacer member is compressed toward the plate spring by the cover so that the plate spring is fixedly compressed to the housing, it is possible to fix the plate spring and the spacer member to the housing without the separate bonding operation. Since the height of the spacer member is elastically changed, it is not necessary to precisely form the height of the spacer member, thereby improving the workability and assembly performance.

Further, since the gap between the housing and the cover is completely closed, it is prevented that the foreign substance is introduced into the camera module.

Since the spacer member is formed of the urethane foam having the uniform cell structure, it is possible to precisely manufacture the small spacer member.

Since the rib portion is formed at each corner of the spacer member and also formed with the fixing hole, and the fixing protrusion that is inserted into the fixing hole is formed at the housing, it is possible to prevent the separation of the spacer member and also it is facile to perform the assembling process.

since the spacer member is formed of the elastic material having the cushion performance, and the spacer member is compressed toward the plate spring by the cover so that the plate spring is fixedly compressed to the housing, it is possible to completely close the gap between the housing and the cover and thus it is prevented that the foreign substance is penetrated into the camera module.

While the present invention has been described with respect to the specific embodiments, it will be apparent to those skilled in the art that various changes and modifications may be made without departing from the spirit and scope of the invention as defined in the following claims.

What is claimed is:

1. A spacer member for a camera module, which is disposed between a cover and a plate spring of the camera module so as to fix a border of the plate spring to a housing, wherein the spacer member is formed of an elastic material having cushion performance, and the spacer member is compressed toward the plate spring by the cover so that the plate spring is fixedly compressed to the housing.

2. The spacer member of claim 1, wherein the spacer member is formed of urethane foam.

3. The spacer member of claim 1, wherein a rib portion is formed at each corner of the spacer member, and the rib portion is formed with a fixing hole, and a fixing protrusion that is inserted into the fixing hole is formed at the housing.

4. A camera module equipped with a spacer module, comprising:
a housing;
a lens holder which is disposed at the housing to be movable up and down, and in which a lens is inserted;
an image sensor which is disposed at a lower side of the lens holder so as to take an image of a subject passing through the lens;
a plate spring which is disposed at an upper side of the housing so as to be contacted with the lens holder and to elastically support the lens holder upward and downward;
a spacer member which is disposed at an upper side of the plate spring so as to fix a border of the plate spring to the housing; and
a cover which is disposed at an upper side of the spacer member so as to cover the spacer member and housing,
wherein the spacer member is formed of an elastic material having cushion performance, and the spacer member is compressed toward the plate spring by the cover so that the plate spring is fixedly compressed to the housing.
